(19) United States
(12) Patent Application Publication
(10) Pub. No.: US 2019/0195004 A1
(43) Pub. Date: Jun. 27, 2019

(54) DOOR AND DOOR SKIN

(71) Applicant: MASONITE CORPORATION, Tampa, FL (US)

(72) Inventors: Alan Pepin, Saint Cloud, FL (US); Patrick C. EGE, Westmont, IL (US)

(21) Appl. No.: 15/784,306

(22) Filed: Oct. 16, 2017

(51) Int. Cl. E06B 3/70

(52) U.S. Cl. CPC E06B 3/7001; E06B 3/72

(57) ABSTRACT

A door skin is provided that includes at least one inner panel, an outer body portion surrounding the at least one inner panel, and at least one contoured portion surrounding the at least one panel and interconnecting the at least one panel to the outer body portion. The at least one contoured portion includes a substantially V-shaped indent area adjacent to and within the outer body portion, a planar area that is substantially parallel to the outer body portion and is adjacent to and within the substantially V-shaped indent area, and a declining area adjacent to and within the planar area and terminating at the inner panel. A door including at least one door skins and a doorframe is also provided.

### FIELD OF THE INVENTION

This invention relates door skins, sometimes known as door facings, and in particularly preferred embodiments of the invention door skins made of cellulosic material and a binder resin. This invention also relates to doors including door skins and a doorframe.

### BACKGROUND

Traditional solid wood doors have become relatively expensive due to raw material costs. A commonplace alternative to traditional solid wood doors in residential and commercial buildings is a door assembly that includes a rectangular doorframe of stiles and rails, and door skins secured to the opposite sides of the doorframe to define a door cavity between the door skins and surrounded by the doorframe. The door skins can be made of, for example, steel, fiberglass composites, cellulosic (e.g., wood) composites such as high density fiberboard (HDF) and medium density fiberboard (MDF), and other materials. Wood grain can be molded or embossed into the exterior surfaces of the door skins. Further, paneling can be formed in the exterior surfaces of the door skins to give an appearance that simulates solid wood products. The door cavity between the door skins typically yet optionally includes one or more core components.

### SUMMARY OF THE INVENTION

According to an embodiment of the invention, a door skin is provided that includes at least one inner panel, an outer body portion surrounding the at least one inner panel, and at least one contoured portion surrounding the at least one panel and interconnecting the at least one panel to the outer body portion, the at least one contoured portion including a substantially V-shaped indent area adjacent to and within the outer body portion, a planar area that is substantially parallel to the outer body portion and is adjacent to and within the substantially V-shaped indent area, and a declining area adjacent to and within the planar area and terminating at the inner panel.

According to another embodiment of the invention, a door is provided that includes a door frame and at least one door skin secured to the door frame. The door skin includes at least one inner panel, an outer body portion surrounding the at least one inner panel, and at least one contoured portion surrounding the at least one panel and interconnecting the at least one panel to the outer body portion, the at least one contoured portion including a substantially V-shaped indent area adjacent to and within the outer body portion, a planar area that is substantially parallel to the outer body portion and is adjacent to and within the substantially V-shaped indent area, and a declining area adjacent to and within the planar area and terminating at the inner panel.

Other aspects of the invention, including door skins, assembled doors, buildings having the doors, related methods, and the like which constitute part of the invention, will become more apparent upon reading the following detailed description of the exemplary embodiments.

### BRIEF DESCRIPTION OF THE DRAWING(S)

The accompanying drawings are incorporated in and constitute a part of the specification. The drawings, together with the general description given above and the detailed description of the exemplary embodiments and methods given below, serve to explain the principles of the invention. In such drawings:

FIG. 1 is a cross-sectional view of a door taken along sectional line 1-1 of FIG. 6 according to an embodiment of the invention;

FIG. 2 is an enlarged fragmented view of a sectional profile region of the door of FIG. 1 taken along sectional line 2-2 of FIG. 6;

FIG. 3 is an enlarged, fragmented, perspective view of a front exterior surface of a door skin illustrating a panel profile according to the invention;

FIG. 4 is an enlarged, fragmented, elevational view of the front exterior surface of the door skin taken within box 4 of FIG. 6.

FIG. 5 is an enlarged, fragmented, elevational view of a rear exterior surface of the front exterior surface fragmented view of FIG. 4;

FIG. 6 is a front elevational view of a door skin according to a first embodiment of the invention;

FIG. 7 is a front elevational view of a door skin according to a second embodiment of the invention having a sectional profile region taken along sectional line 2-2 of FIG. 7 that is identical to the sectional profile region of FIG. 2;

FIG. 8 is a front elevational view of a door skin according to a third embodiment of the invention having a sectional profile region taken along sectional line 2-2 of FIG. 8 that is identical to the sectional profile region of FIG. 2;

FIG. 9 is a front elevational view of a door skin according to a fourth embodiment of the invention having a sectional profile region taken along sectional line 2-2 of FIG. 9 that is identical to the sectional profile region of FIG. 2;

FIG. 10 is a front elevational view of a door skin according to a fifth embodiment of the invention having a sectional profile region taken along sectional line 2-2 of FIG. 10 that is identical to the sectional profile region of FIG. 2;

FIG. 11 is a front elevational view of a door skin according to a sixth embodiment of the invention having a sectional profile region taken along sectional line 2-2 of FIG. 11 that is identical to the sectional profile region of FIG. 2;

FIG. 12 is a front elevational view of a door skin according to a seventh embodiment of the invention having a sectional profile region taken along sectional line 2-2 of FIG. 12 that is identical to the sectional profile region of FIG. 2;

FIG. 13 is a front elevational view of a door skin according to an eighth embodiment of the invention having a sectional profile region taken along sectional line 2-2 of FIG. 13 that is identical to the sectional profile region of FIG. 2;

FIG. 14 is a front elevational view of a door skin according to a ninth embodiment of the invention having a sectional profile region taken along sectional line 2-2 of FIG. 14 that is identical to the sectional profile region of FIG. 2;

FIG. 15 is an enlarged, fragmented, perspective view of a front exterior surface of a door skin having a wood grain appearance;

FIG. 16 is an enlarged, fragmented, elevational view of the front exterior surface of the door skin taken within box 16 of FIG. 18;

FIG. 17 is an enlarged, fragmented, elevational view of a rear exterior surface of the front exterior surface fragmented view of FIG. 16;

FIG. 18 is a front elevational view of a door skin according to a tenth embodiment of the invention;

FIG. 19 is a front elevational view of a door skin according to an eleventh embodiment of the invention having a sectional profile region taken along sectional line 2-2 of FIG. 19 that is identical to the sectional profile region of FIG. 2;

FIG. 20 is a front elevational view of a door skin according to a twelfth embodiment of the invention having a sectional profile region taken along sectional line 2-2 of FIG. 20 that is identical to the sectional profile region of FIG. 2;

FIG. 21 is a front elevational view of a door skin according to a thirteenth embodiment of the invention having a sectional profile region taken along sectional line 2-2 of FIG. 21 that is identical to the sectional profile region of FIG. 2;

FIG. 22 is a front elevational view of a door skin according to a fourteenth embodiment of the invention having a sectional profile region taken along sectional line 2-2 of FIG. 22 that is identical to the sectional profile region of FIG. 2;

FIG. 23 is a front elevational view of a door skin according to a fifteenth embodiment of the invention having a sectional profile region taken along sectional line 2-2 of FIG. 23 that is identical to the sectional profile region of FIG. 2;

FIG. 24 is a front elevational view of a door skin according to a sixteenth embodiment of the invention having a sectional profile region taken along sectional line 2-2 of FIG. 24 that is identical to the sectional profile region of FIG. 2;

FIG. 25 is a front elevational view of a door skin according to a seventeenth embodiment of the invention having a sectional profile region taken along sectional line 2-2 of FIG. 25 that is identical to the sectional profile region of FIG. 2; and

FIG. 26 is a front elevational view of a door skin according to an eighteenth embodiment of the invention having a sectional profile region taken along sectional line 2-2 of FIG. 26 that is identical to the sectional profile region of FIG. 2.

### DETAILED DESCRIPTION OF THE EXEMPLARY EMBODIMENTS AND EXEMPLARY METHODS

Reference will now be made in detail to exemplary embodiments and methods of the invention. It should be noted, however, that the invention in its broader aspects is not necessarily limited to the specific details, representative materials and methods, and illustrative examples shown and described in connection with the exemplary embodiments and methods.

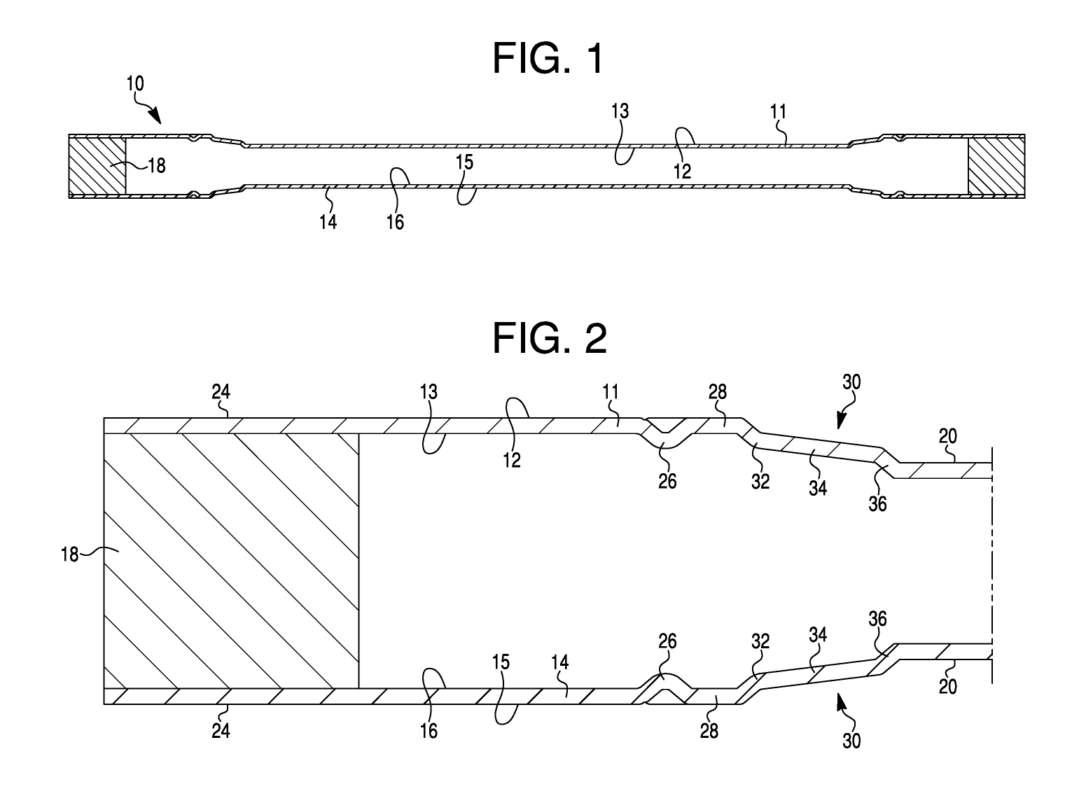

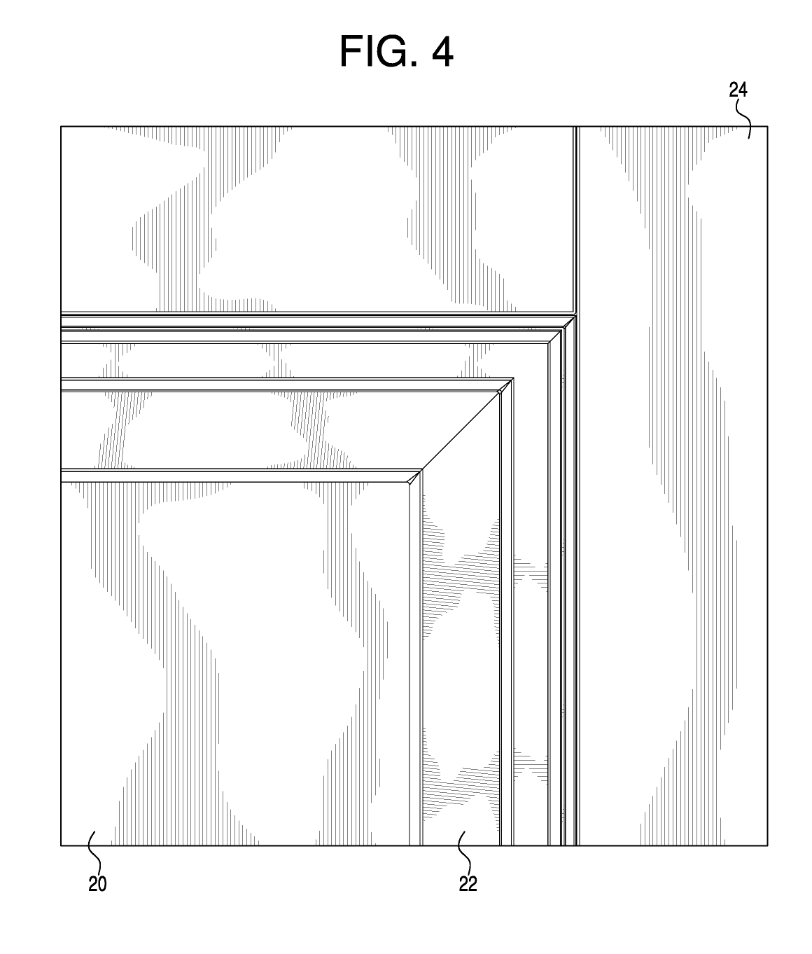

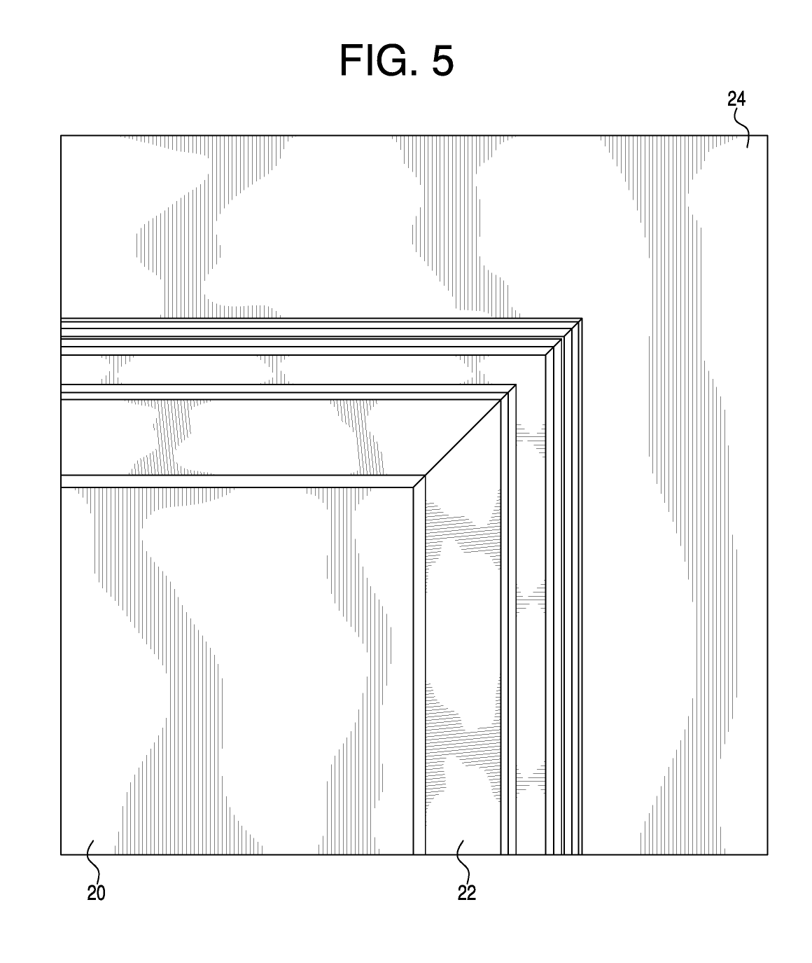

Referring to FIGS. 1-6, there is illustrated a first embodiment of a single-panel door, generally designated by reference numeral 10, including a first door skin 11 and a second door skin 14. The door skins 11 and 14 may be identical, as shown, by molding the skins 11, 14 in the same molding apparatus and from the same materials. The first door skin 11 has a first exterior surface 12 and an opposite first interior surface 13. Likewise, the second door skin 14 has a second exterior surface 15 and an opposite second interior surface 16. The first and second exterior surfaces 12 and 15 are opposite or face away from one another. The first and second interior surfaces 13 and 16 face towards one another. Although not shown in FIGS. 1-6, the first and second exterior surfaces 12 and 15 may be molded, embossed, or otherwise provided with a surface pattern or texture, such as a wood grain pattern and/or wood tonal areas that replicate the natural background tones of natural wood. The exterior surfaces 12 and 15 may have one or more coatings, which may include, for example, paint, stain, lacquer, and/or a protective finish. A frame 18 positioned about the periphery of the door skins 11 and 14 contacts and is adhered or otherwise secured to the first and second interior surfaces 13 and 16. Although not shown, a door core may be positioned between the first and second door skins 11 and 14.

The door skins 11 and 14 may be made from wood composite materials such as medium density fiberboard (MDF) or high density fiberboard (HDF), fiberglass-reinforced polymer materials, metal (e.g., steel), or other materials. Preferably, the door skins 11 and 14 are molded wood composite articles made from a cellulosic mat containing a combination of cellulosic fibers and a natural or synthetic binder, such as a phenol formaldehyde or urea formaldehyde resin. The frame 18 may be made of wood, composite materials, metal, or other materials. The door cavity between the door skins typically yet optionally includes one or more core components (not shown). The core component(s) can be a pre-formed structure or formed in situ, such as by injecting a foam precursor composition into the door cavity and allowing the precursor composition to expand and fill the door cavity with foam.

The making of door skins in general and assembling of doors is known in the art, as described for example in U.S. Pat. No. 5,543,234 to Lynch et al. and U.S. Pat. No. 9,657,512.

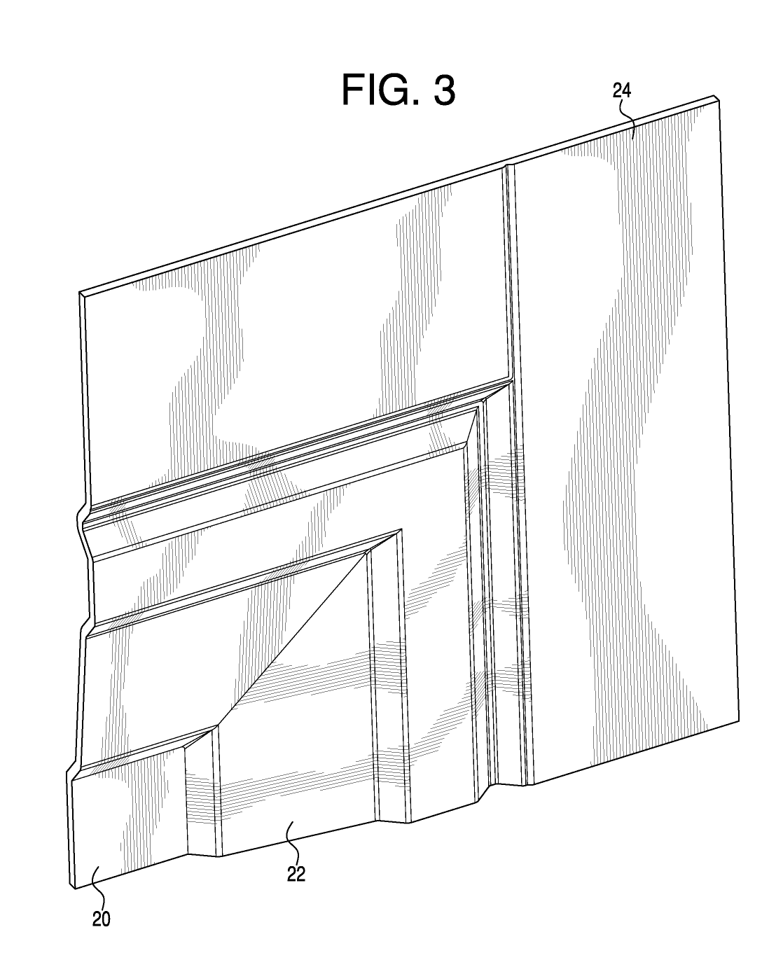

The first and second door skins 11 and 14 of the first illustrated embodiment of FIGS. 1-6 are each a one-panel skin having an inner panel 20, an outer body portion or outer skirt 24 surrounding the inner panel 20, and a contoured portion or ovalo 22 interconnecting and integrally formed as a unitary piece with the inner panel 20 and the outer body portion 24. When viewed from the exterior side of the door skin 11, the contoured portion 22 defines a continuous depression extending into the planar portions of the exterior surface 12 toward the door core and around the entire periphery of inner panel 20. The contoured portion 22 preferably is continuous and has a uniform cross section, best shown in FIGS. 1 and 2, about its entire length. The door skins 11 and 14 each preferably are substantially uniform in thickness.

As best shown in FIG. 2, the contoured portions 22 replicate fine millwork. Each contoured portion 22 includes a substantially V-shaped indent area 26 immediately adjacent to and within or interior relative to the outer body portion 24, a planar area 28 immediately adjacent to and within the substantially V-shaped indent area 26 that is substantially parallel to the outer body portion 24, and a declining or tapering area 30 immediately adjacent to and within the planar area 28 that terminates at the inner panel 20. The declining area 30 has three angled zones 32, 34, and 36 interconnected to one another, with the inner and outer angled zones 32 and 36 declining or tapering at a greater rate than the intermediate angled zone 34 therebetween. Due mostly to the declining or tapering areas 30, the inner panels 20 of the first and second door skins 11 and 14 are spaced more closely to one another than the outer body portions 24 of the door skins 11 and 14.

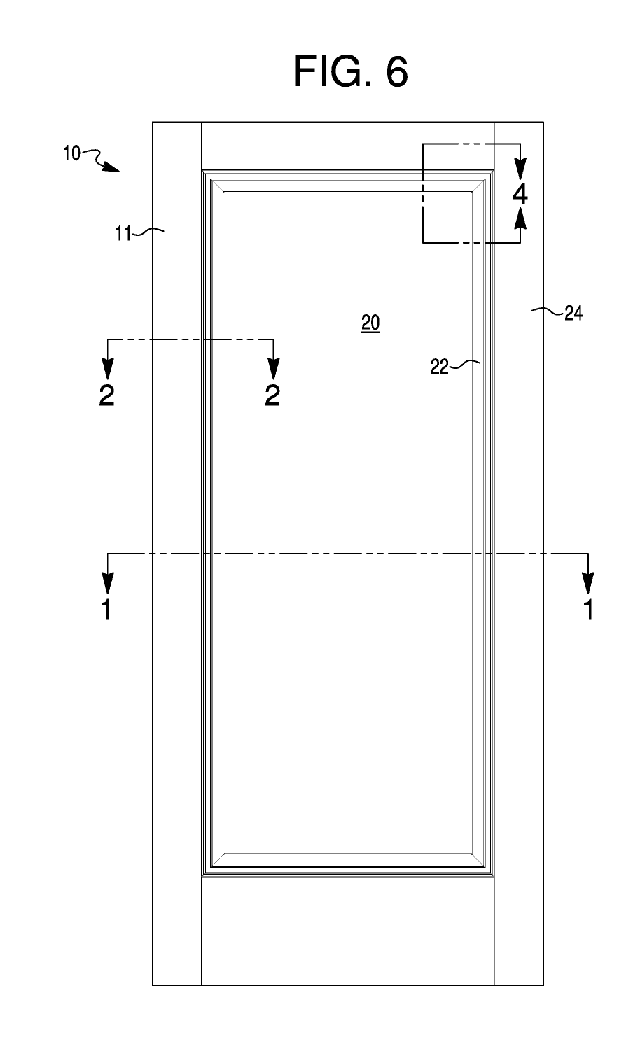

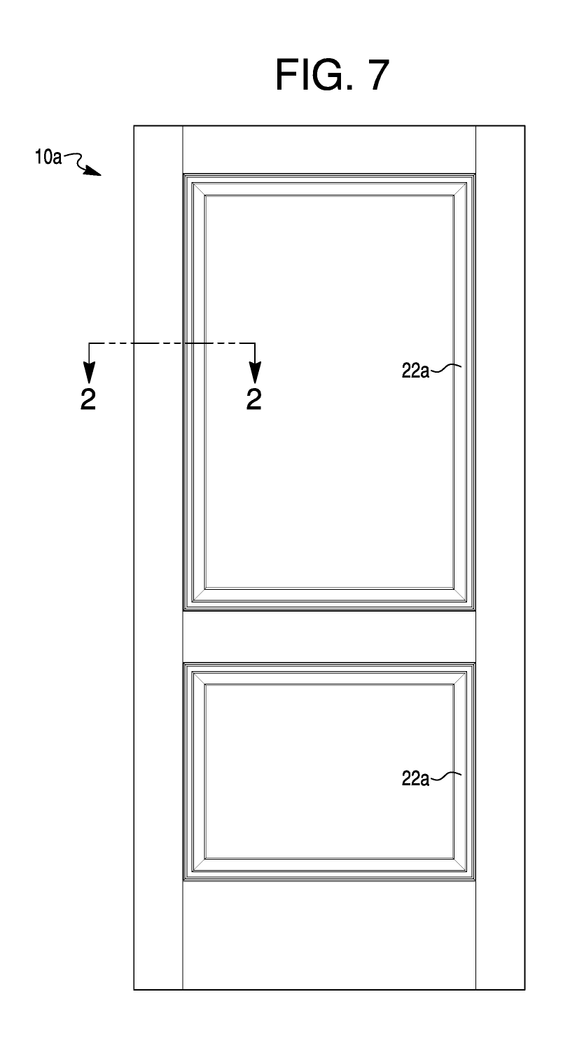

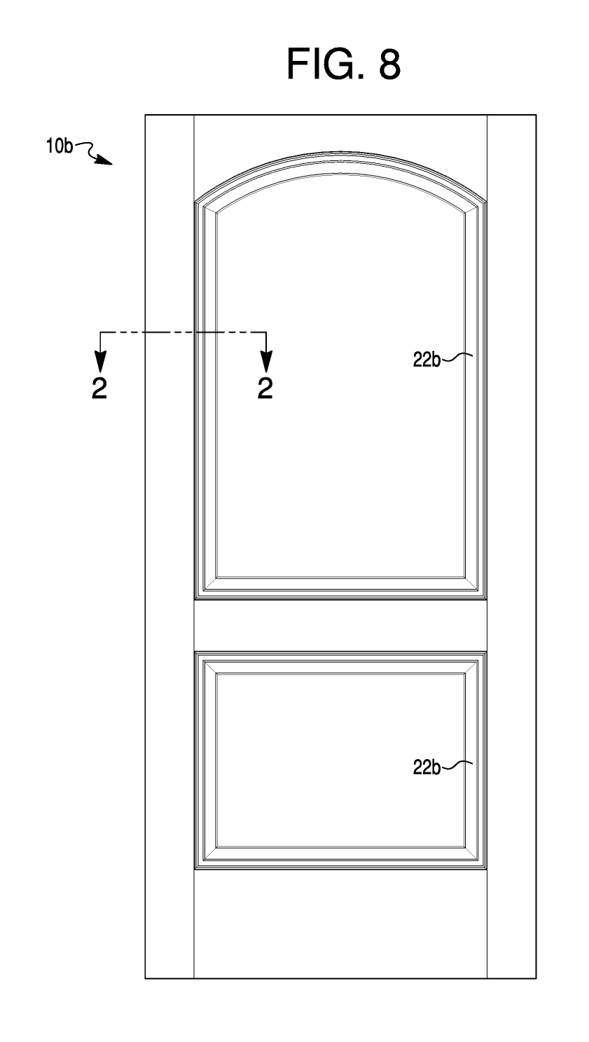

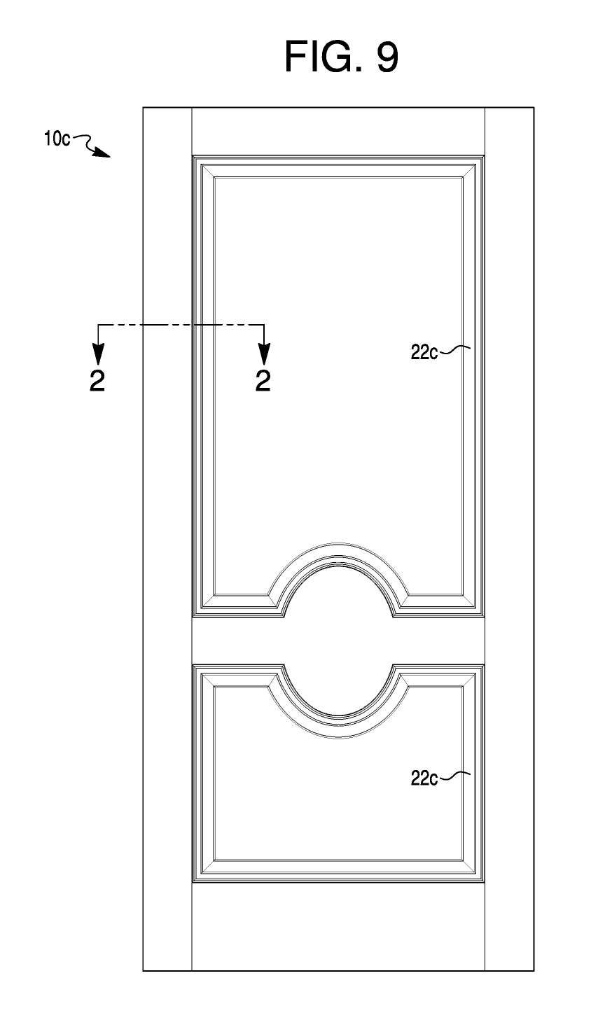

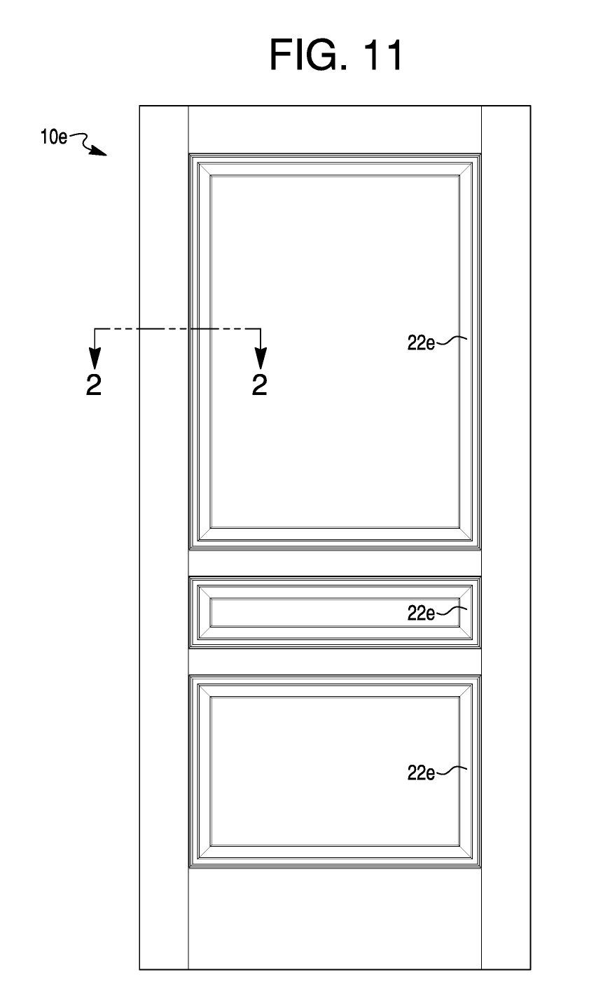

As best shown in FIG. 6, the single contoured portion 22 of the first embodiment has a continuous and uniform rectangular appearance from a front elevational viewpoint. FIGS. 7-14 illustrate exemplary embodiments of variations and modifications to the design of the door skins 11 and 14 that may be implemented. The encircling contoured portions 22a, 22b, 22c, 22d, 22e, 22f, 22g, and 22h of the door skins 10a, 10b, 10c, 10d, 10e, 10f, 10g, and 10h of each embodiment of FIGS. 7-14 have the same cross-sectional profile region as the contoured portion 22 of door skin 10 shown in FIG. 2.

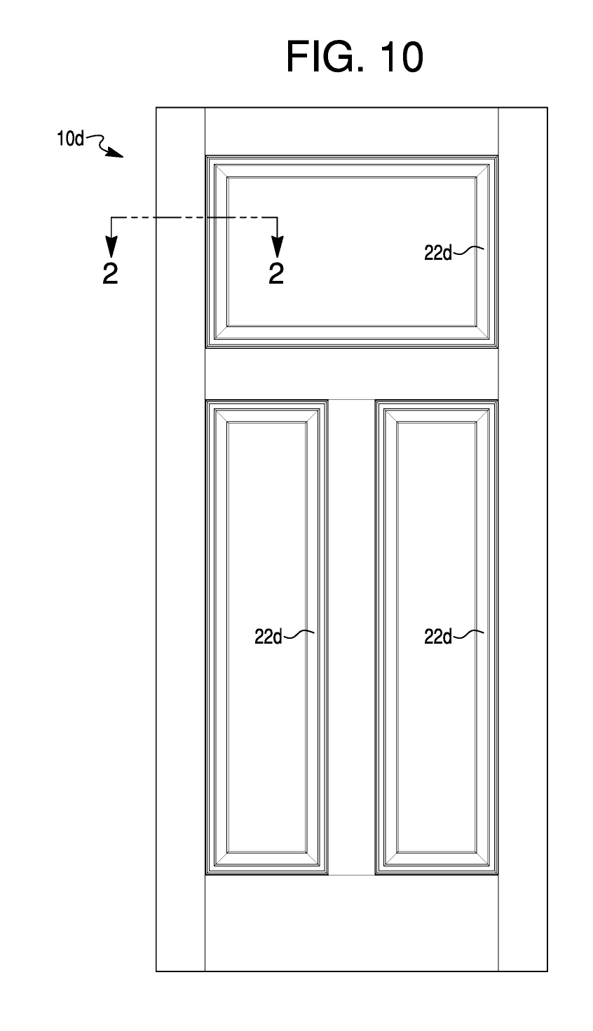

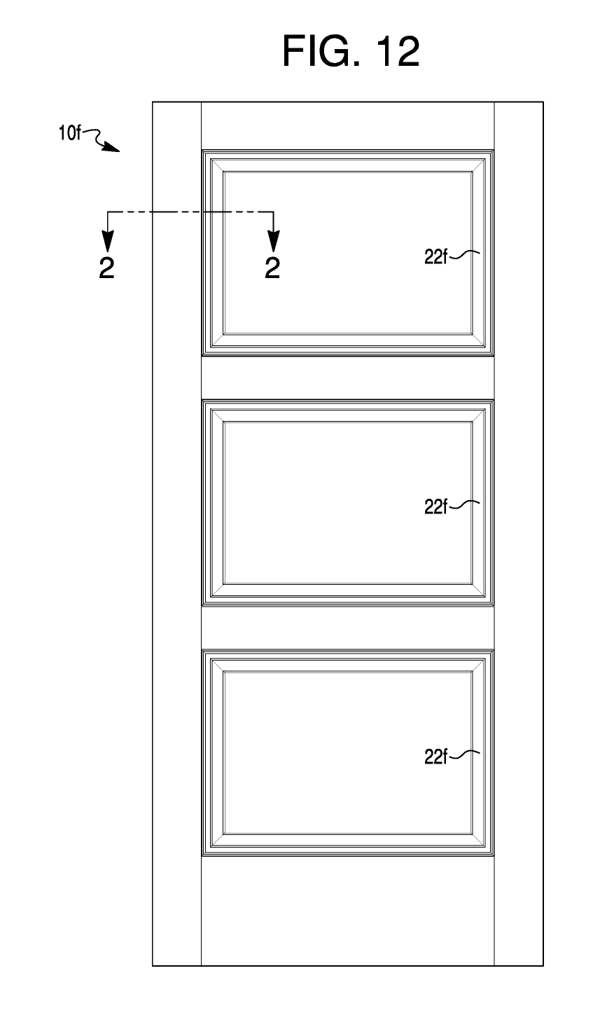

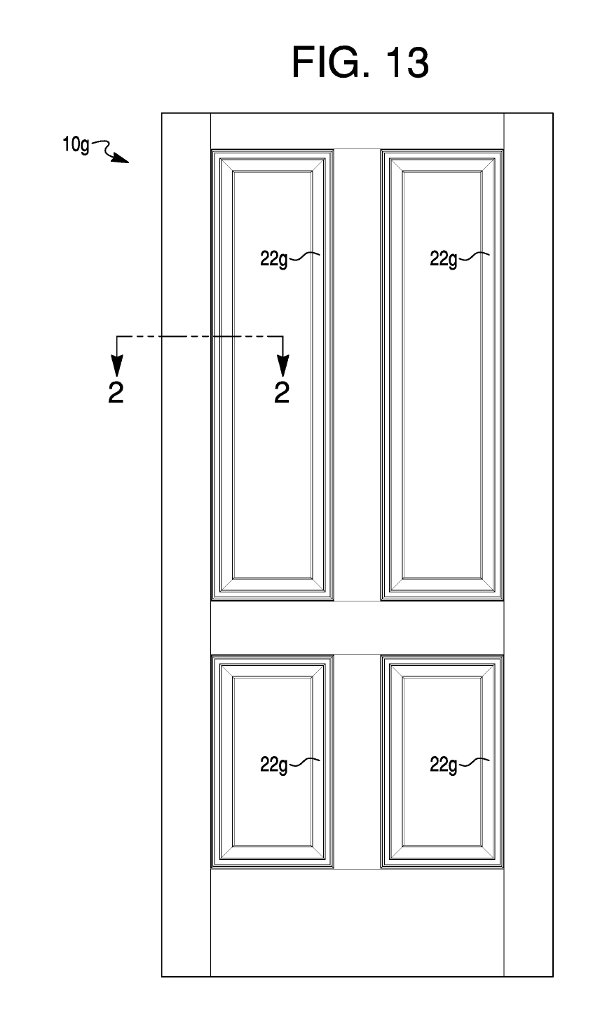

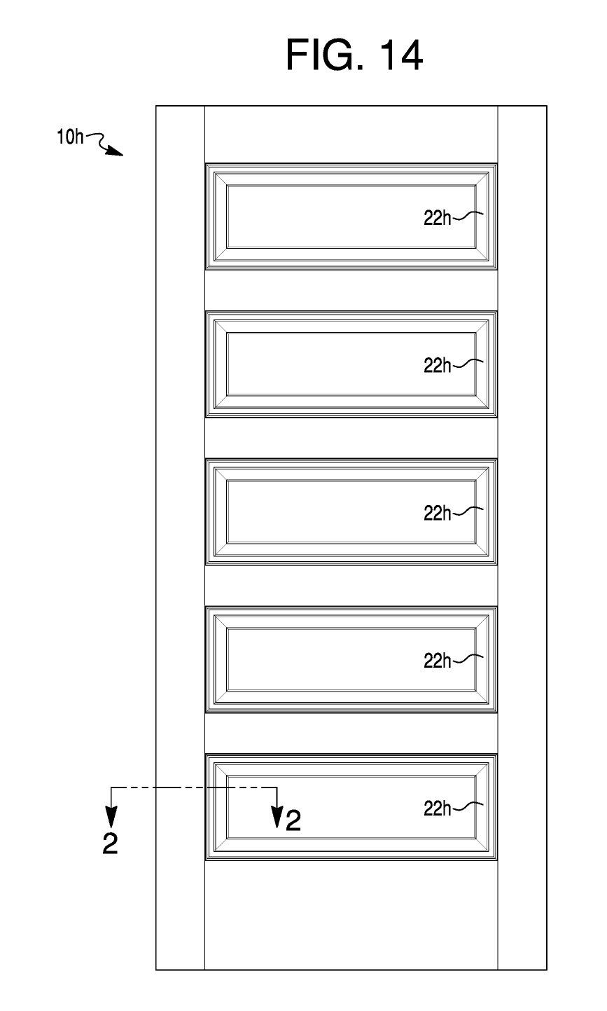

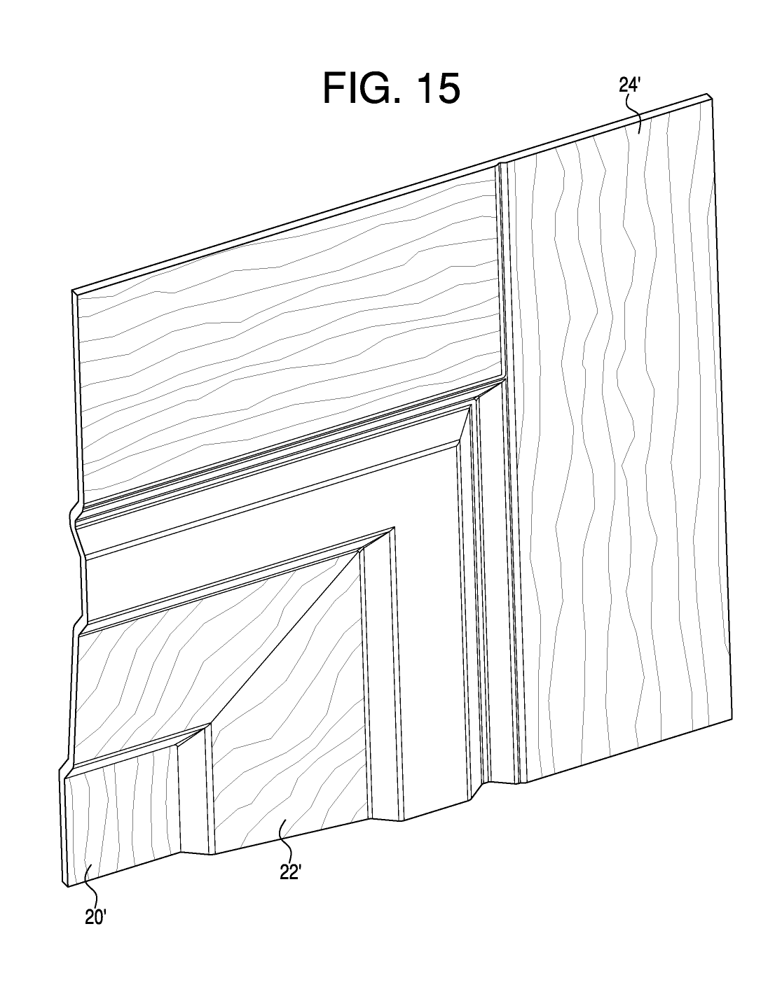

While FIG. 6 illustrates an embodiment of a door skin 11 with one inner panel 20, the number of inner panels 20 may be varied. For example, the door skins 11 and 14 may have two inner panels with two contoured portions (e.g., the embodiments of FIGS. 7-9), three inner panels with three contoured portions (e.g., the embodiments of FIGS. 10-12), four inner panels with four contoured portions (e.g., the embodiment of FIG. 13), five inner panels with five contoured portions (e.g., the embodiment of FIG. 14), or more inner panels and associated contoured portions. The inner panels 20 may be arranged in vertically stacked configurations (e.g., the inner panels of the embodiments of FIGS. 7-9, 11, 12, and 14), side-by-side juxtaposed configurations, or a combination of vertically stacked and side-by-side juxtaposeed configurations (e.g., the inner panels of the embodiments of FIGS. 10 and 13). The perimeters of the inner panels may establish other shapes, such as other polygons, circles, ovals, etc. The inner panels may have the same shapes (e.g., the inner panels of FIGS. 12 and 14) or different shapes (e.g., the inner panels of FIGS. 7-11 and 13) and/or dimensions from one another.

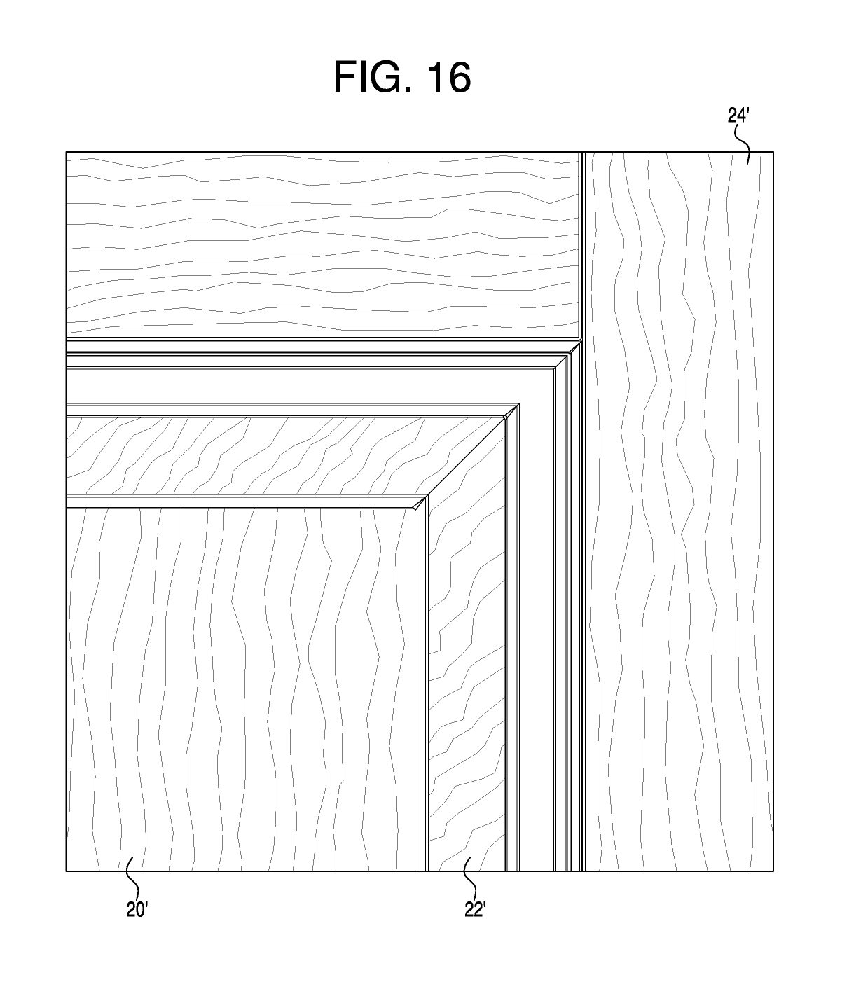

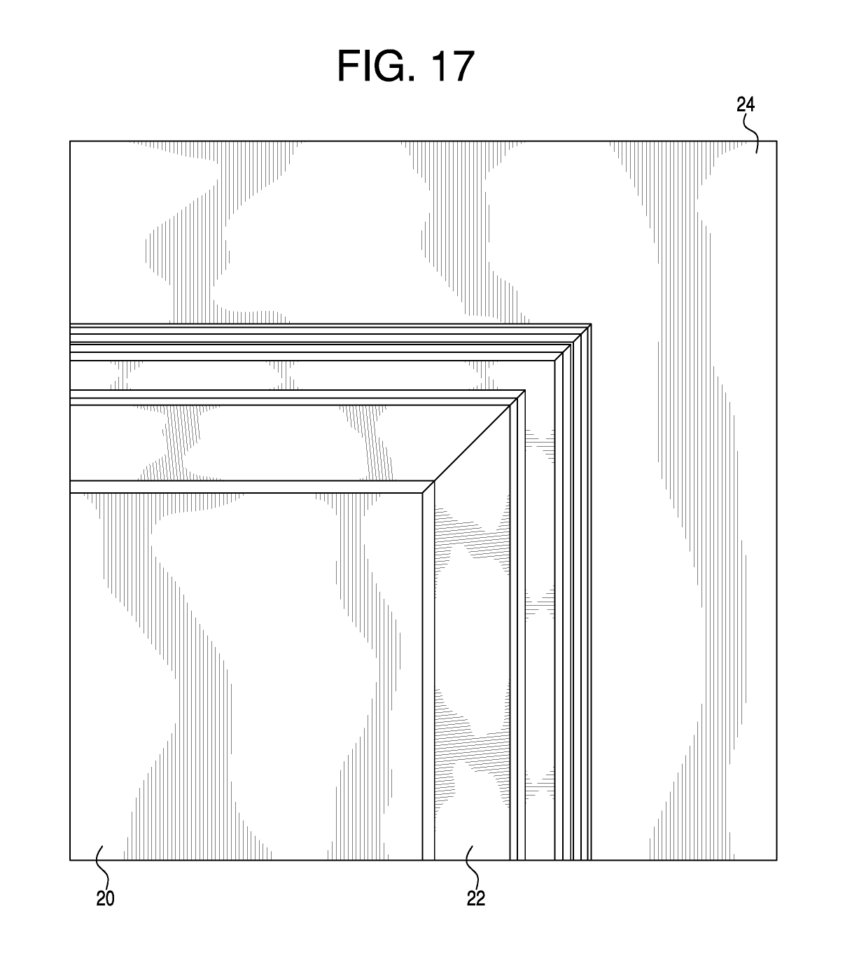

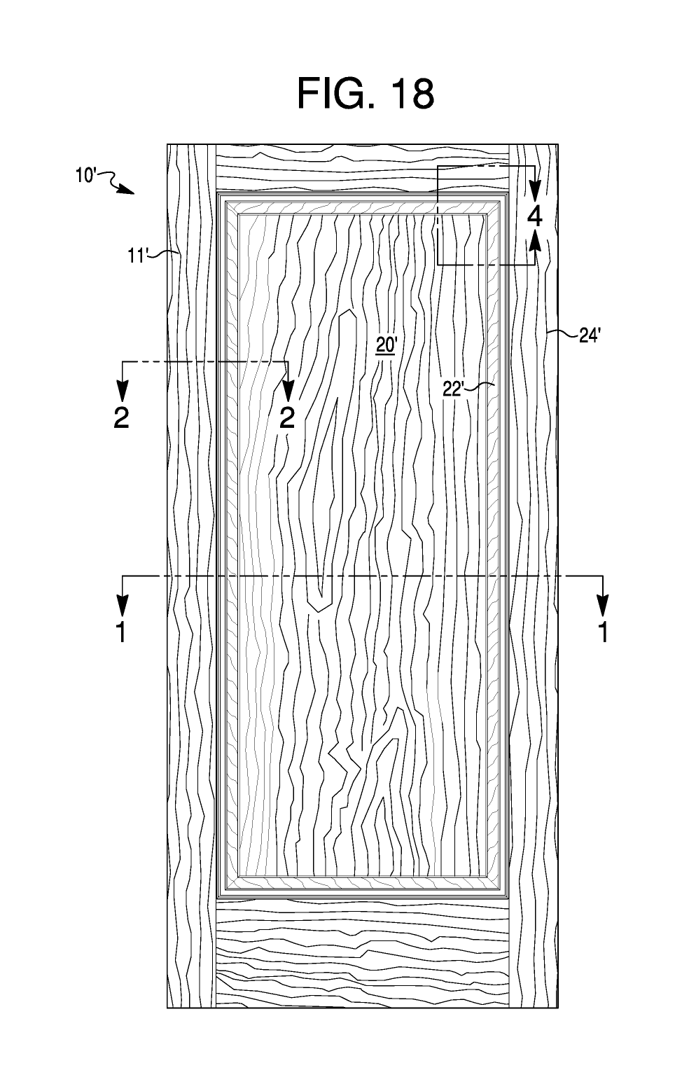

The door skins 11 and 14 may have an identical or different arrangement of inner panels and other surface features (e.g., embossed wood grain) on their respective exterior surfaces 12 and 15. FIGS. 15-18 illustrates a door 10′ that is identical to door 10 of FIGS. 3-6, except for the addition of a wood grain pattern in the exterior surface of the door skins. The door 10′ includes a first door skin 11′ and a second door skin (not shown in FIGS. 15-18 but identical to the second door skin 14 but with a wood grain pattern added). The first door skin 11′ has a first exterior surface and an opposite first interior surface. Likewise, the second door skin has a second exterior surface and an opposite second interior surface. The first and second door skins of the embodiment of FIGS. 15-18 are each a one-panel skin having an inner panel 20′, an outer body portion or outer skirt 24′ surrounding the inner panel 20′, and a contoured portion or ovalo 22′ interconnecting and integrally formed as a unitary piece with the inner panel 20′ and the outer body portion 24′. When viewed from the exterior side of the door skin 11′, the contoured portion 22′ defines a continuous depression extending into the planar portions of the exterior surface toward the door core. The contoured portion 22′ has a sectional profile taken along sectional lines 1-1 and 2-2 of FIG. 18 that is identical to the sectional profile of FIGS. 1 and 2.

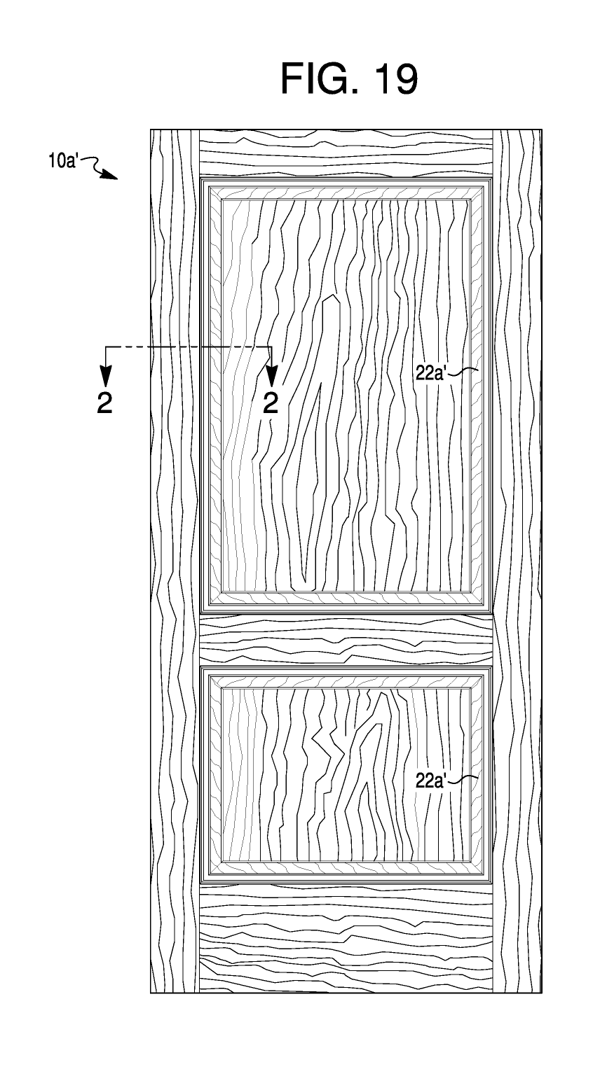

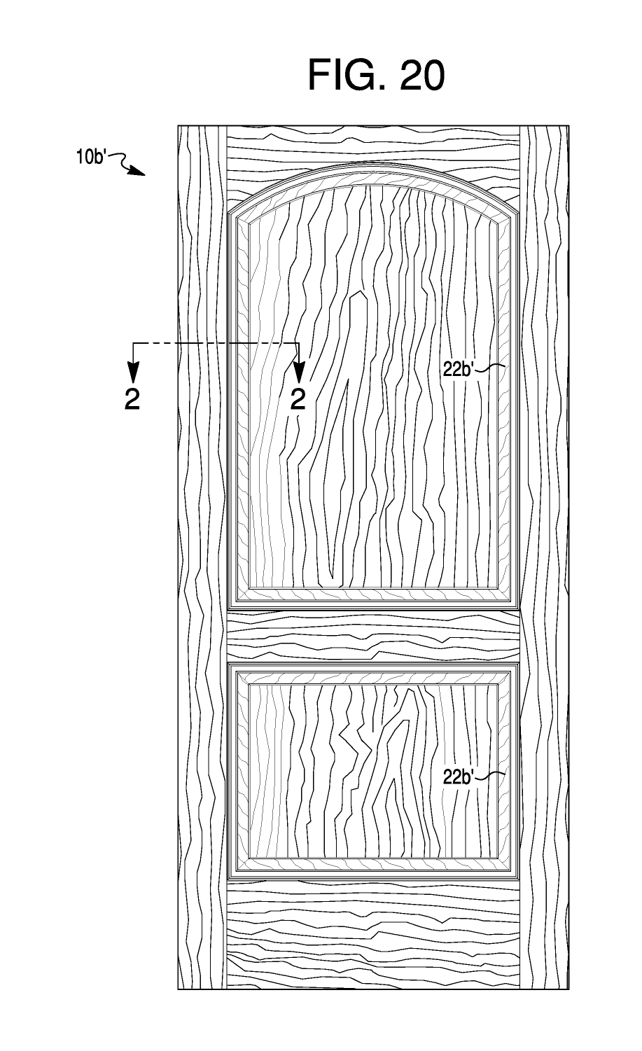

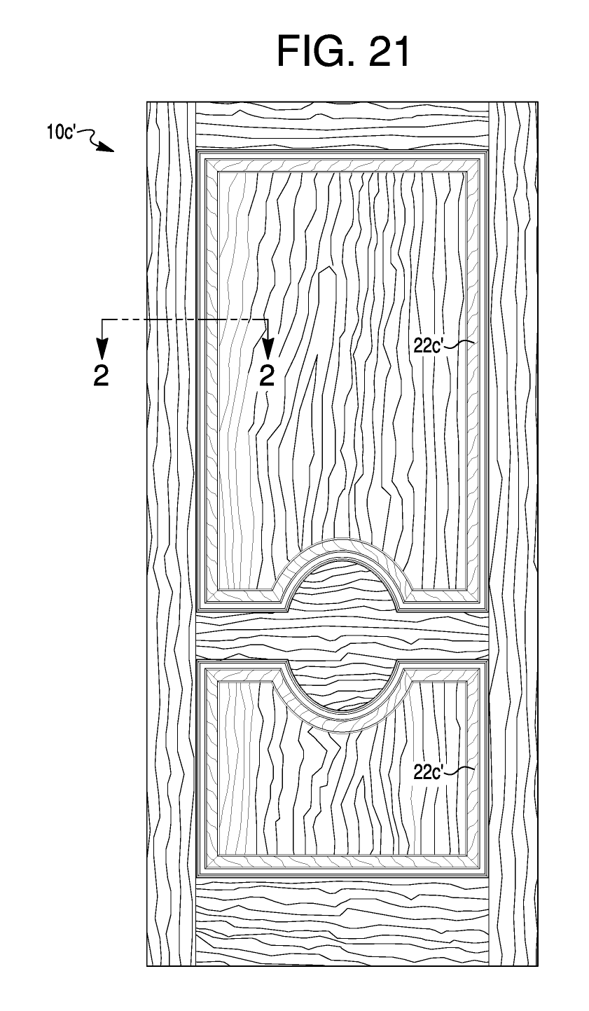

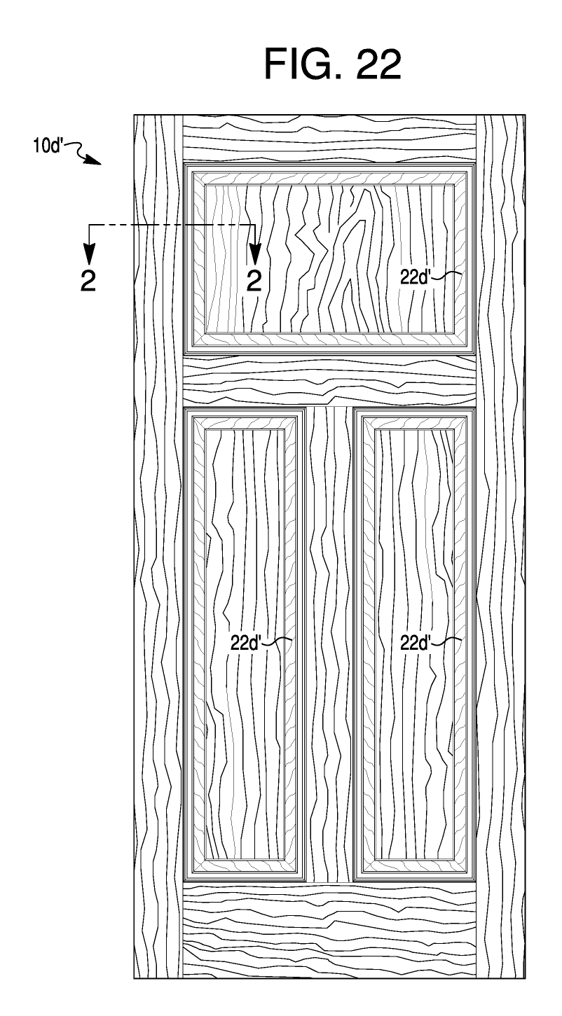

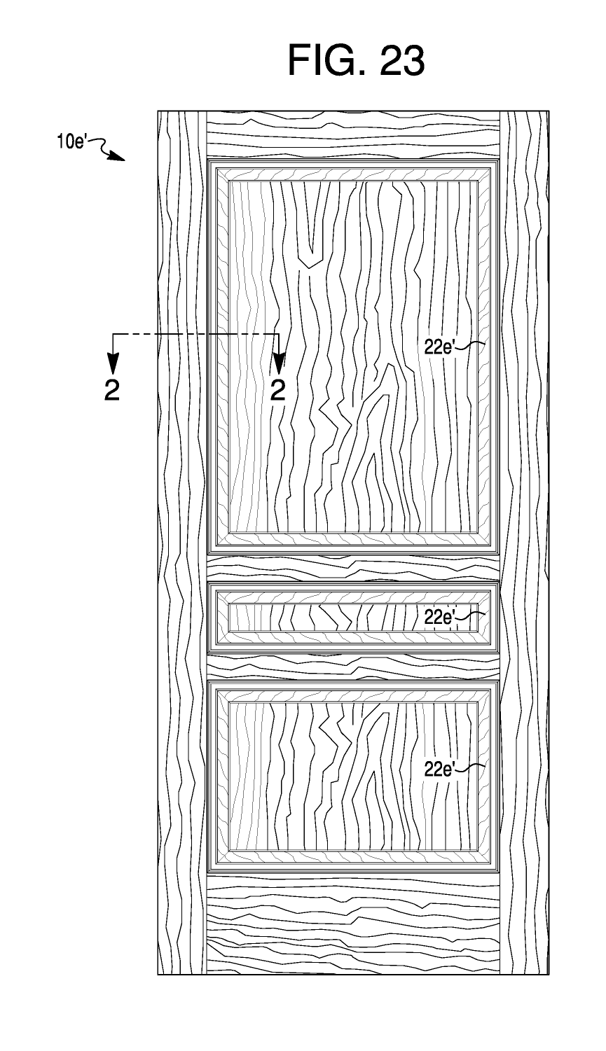

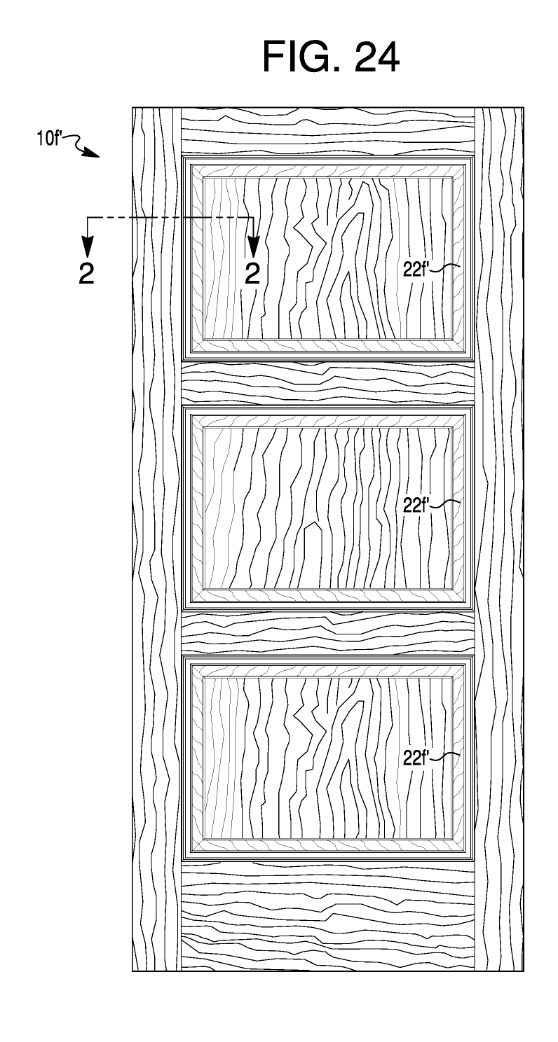

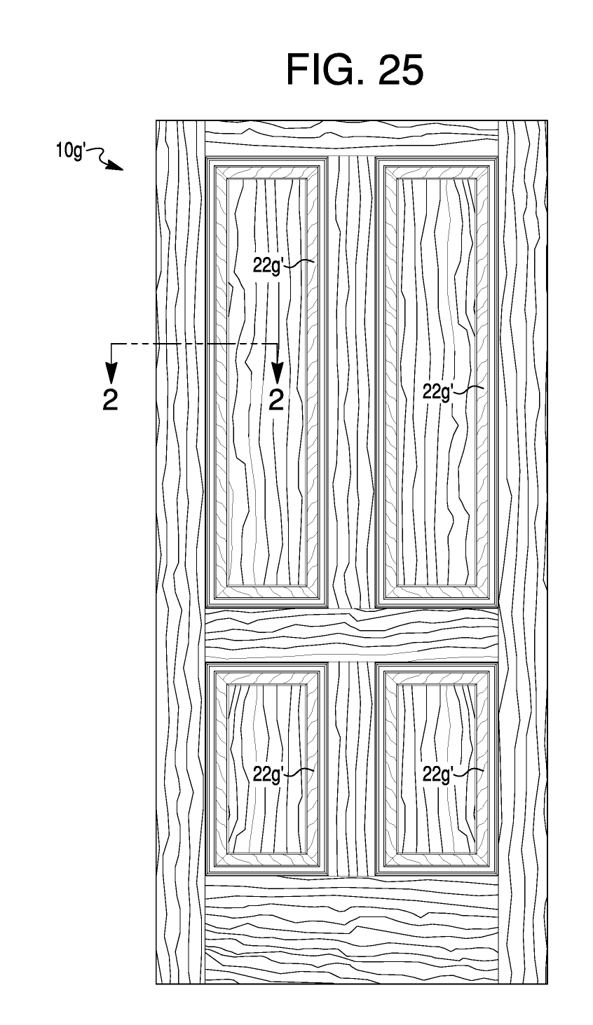

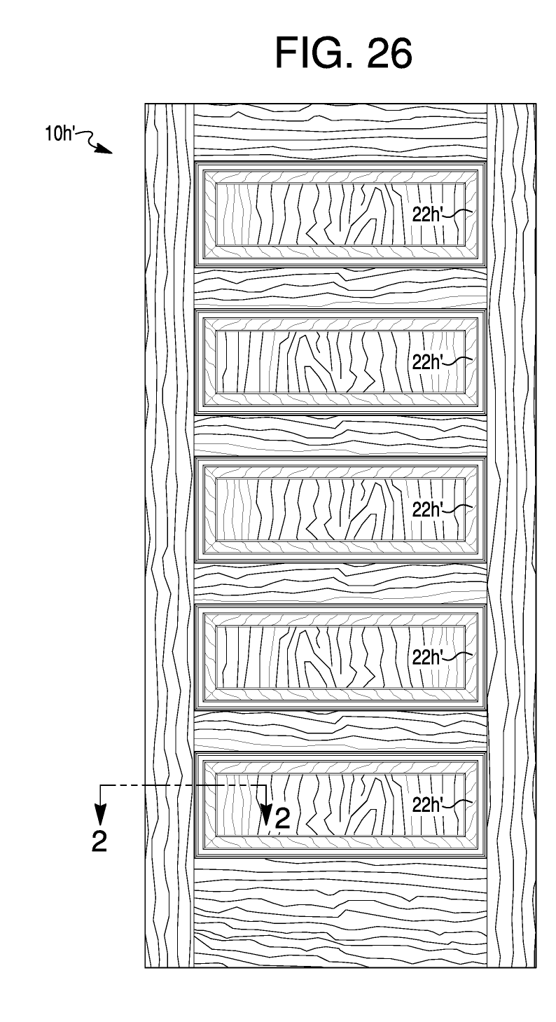

FIGS. 19-26 illustrate doors 10a′, 10b′, 10c′, 10d′, 10e′, 10f′, 10g′, and 10h′, respectively, having door skins including panel arrangements with encircling contoured portions 22a′, 22b′, 22c′, 22d′, 22e′, 22f′, 22g′, and 22h′, that are identical to FIGS. 7-14, respectively, except that the exterior surfaces of the door skin of the doors 10a′, 10b′, 10c′, 10d′, 10e′, 10f′, 10g′, and 10h′ of FIGS. 19-26 are provided with wood grain patterns. Those skilled in the art will understand that the wood grain pattern may be applied or formed also with the profile portions 22a′, 22b′, 22c′, 22d′, 22e′, 22f′, 22g′, and 22h′.

The foregoing detailed description of the certain exemplary embodiments has been provided for the purpose of explaining the principles of the invention and its practical application, thereby enabling others skilled in the art to understand the invention for various embodiments and with various modifications as are suited to the particular use contemplated. This description is not necessarily intended to be exhaustive or to necessarily limit the invention to the precise embodiments disclosed.

1. A door skin comprising:
at least one inner panel;
an outer body portion surrounding the at least one inner panel and parallel to the inner panel; and
at least one contoured portion surrounding the at least one inner panel and interconnecting the at least one inner panel to the outer body portion, the at least one contoured portion comprising
a V-shaped indent area adjacent to and surrounded by the outer body portion, the V-shaped indent area surrounding the at least one inner panel,
a planar area that is parallel to the outer body portion, and is adjacent to and surrounded by the V-shaped indent area, and
a declining area adjacent to and surrounded by the planar area and terminating at the inner panel.

2. The door skin of claim 1, wherein the declining area comprises first and second planar declining angled zones and an intermediate planar declining angled zone between the first and second planar declining angled zones.

3. The door skin of claim 2, wherein the first and second planar declining angled zones decline at a greater rate than the intermediate planar declining angled zone.

4. The door skin of claim 1, wherein the planar area is coplanar with the outer body portion.

5. The door skin of claim 1, wherein the inner panel is continuous and flat and positioned centermost relative to the contoured portion.

6. The door skin of claim 1, wherein the door skin comprises a wood composite composition.

7. The door skin of claim 1, wherein the door skin comprises a fiberglass-reinforced polymer.

8. The door skin of claim 1, wherein the at least one contoured portion is formed as a unitary piece with the at least one inner panel and the outer body portion.

9. A door comprising:
a door frame having opposite first and second sides;
the door skin of claim 1 secured to the first side of the door frame; and
an additional door skin identical to the door skin of claim 1 secured to the second side of the door frame.

10. The door of claim 9, wherein the inner panels of the door skin and the additional door skin are spaced relative to one another more closely than the outer body portions of the door skin and the additional door skin are spaced relative to one another.

11. A door skin comprising:
at least one inner panel;
an outer body portion surrounding the at least one inner panel and parallel to the inner panel; and
at least one contoured portion surrounding the at least one inner panel and interconnecting the at least one inner panel to the outer body portion, the at least one contoured portion comprising
a V-shaped indent area adjacent to and surrounded by the outer body portion, the V-shaped indent area surrounding the at least one inner panel,
a planar area that is parallel to the outer body portion, and is adjacent to and surrounded by the V-shaped indent area, and
a declining area adjacent to and surrounded by the planar area, the declining area comprising first and second planar declining angled zones and an intermediate planar declining angled zone between the first and second planar declining angled zones.

12. The door skin of claim 11, wherein the first and second planar declining angled zones decline at a greater rate than the intermediate planar declining angled zone.

13. The door skin of claim 11, wherein the planar area is coplanar with the outer body portion.

14. The door skin of claim 11, wherein the inner panel is continuous and flat and positioned centermost relative to the contoured portion.

15. The door skin of claim 11, wherein the door skin comprises a wood composite composition.

16. The door skin of claim 11, wherein the door skin comprises a fiberglass-reinforced polymer.

17. The door skin of claim 11, wherein the at least one contoured portion is formed as a unitary piece with the at least one inner panel and the outer body portion.

18. A door comprising:
a door frame having opposite first and second sides;
the door skin of claim 11 secured to the first side of the door frame; and
an additional door skin identical to the door skin of claim 11 secured to the second side of the door frame.

19. The door of claim 18, wherein the inner panels of the door skin and the additional door skin are spaced relative to one another more closely than the outer body portions of the door skin and the additional door skin are spaced relative to one another.
